(19) United States
(12) Patent Application Publication
(10) Pub. No.: US 2013/0236740 A1
(43) Pub. Date: Sep. 12, 2013

(54) HIGH STRENGTH HOT DIP GALVANNEALED STEEL SHEET OF EXCELLENT PHOSPHATABILITY AND DUCTILITY, AND A PRODUCTION PROCESS THEREFOR

(71) Applicant: KABUSHIKI KAISHA KOBE SEIKO SHO (KOBE STEEL, LTD.), Kobe-shi (JP)

(72) Inventors: Takeshi Kojima, Kakogawa-shi (JP); Hiroshi Irie, Kakogawa-shi (JP)

(73) Assignee: KABUSHIKI KAISHA KOBE SEIKO SHO (Kobe Steel, Ltd.), Kobe-shi (JP)

(21) Appl. No.: 13/752,816

(22) Filed: Jan. 29, 2013

(30) Foreign Application Priority Data
Mar. 8, 2012 (JP) 2012-051758

(51) Int. Cl. B32B 15/01

(52) U.S. Cl. CPC B32B 15/013
USPC 428/659; 427/372.2

(57) ABSTRACT

For obtaining a hot dip galvannealed steel sheet having high strength and high ductility and excellent phosphatability, a chemical composition of a material steel sheet for forming the hot dip galvannealed steel sheet comprises 0.4 to 2.0 mass % of Si and 1.0 to 3.5 mass % of Mn, and an average Mn concentration for a region from the uppermost surface to 0.01 μm depth in the coating layer is defined as 0.14% or more.

### FIELD OF THE INVENTION

The present invention concerns a high strength hot dip galvannealed steel sheet of excellent phosphatability and ductility, and a production process therefor.

### BACKGROUND OF THE INVENTION

Since hot dip galvannealed steel sheets prepared by applying a heat treatment to hot dip galvanized steel sheets thereby alloying a hot dip galvanized layer and a material steel sheet (steel sheets before hot dip galvanization) are excellent in corrosion resistance and spot weldability, they are used in a wide range of applications, for example, automobiles, home electronics products, building materials, and, particularly, as materials for automobiles.

Upon application to the materials for the automobiles, reduction of thickness by increasing the strength of the material steel sheets has been demanded in order to improve the fuel cost by reduction in the weight of car bodies and safety upon corrosion together. However, when the strength of the material steel sheet is increased, the ductility is worsened to deteriorate the workability. Then, the material steel sheet is required to have good balance between the strength and the ductility.

As a method of outstandingly improving both of characteristics of the strength and the ductility while maintaining good balance between the strength and the ductility, addition of Si or Mn at high concentration has been known. For example, Japanese Unexamined Patent Application Publication No. 2005-187883 proposes an alloyed hot dip galvannealed steel sheet having 590 MPa or more of strength and 10% or more of ductility using a high silicon steel as a material steel sheet and produced by an oxidation and reduction method.

However, the alloyed hot dip galvannealed steel sheet containing Si or Mn at high concentration in the material steel sheet prepared by such a method involves a problem of low phosphatability although the cause therefor has not yet been apparent. Then, it has been demanded to improve the phosphatability of an alloyed hot dip galvannealed steel sheet containing relatively large amount of Si and Mn in the material steel sheet and several proposals have been provided so far.

For example, Japanese Patent Unexamined Application Publication No. 2007-231376 discloses a technique of forming an oxide layer containing Zn—OH bonds and having an average thickness of 10 nm or more to a planar surface layer of a galvanized steel sheet, thereby preventing formation of ZnO, FeO, etc. that less form phosphate crystal as much as possible and improving the phosphatability. Further, it is described in Japanese Patent Unexamined Application Publication No. H08-296015 and U.S. Pat. No. 8,025,980 that the phosphatability can be improved by precipitating oxides mainly comprising ZnO.

### SUMMARY OF THE INVENTION

In view of the problems that the phosphatability is deteriorated even in a hot dip galvannealed steel sheet containing Si and Mn at high concentration in the material steel sheet which is produced by an oxidation and reduction method as described above, the present inventors have made a study with a view point different from that of the existent technique. The present invention intends to obtain a hot dip galvannealed steel sheet containing Si or Mn at high concentration, having high strength and high ductility, as well as excellent in the phosphatability.

The hot dip galvannealed steel sheet of the invention capable of solving the problem described above has a chemical composition in a material steel sheet comprising 0.4 to 2.0% of Si (mass % in chemical composition here and hereinafter) and 1.0 to 3.5% of Mn in which an average Mn concentration for a region from the uppermost surface to 0.01 μm depth of the coating layer is 0.14% or more.

The chemical composition of the material steel sheet mainly comprises 0.03 to 0.30% of C, 0.1% or less of P, 0.01% or less of S, and 0.01 to 0.5% of Al.

The Mn concentration in the entire coating layer is preferably less than 1.0%.

The present invention also provides a process for producing the hot dip galvannealed steel sheet in which the production process includes a step of using a material steel sheet having the chemical composition as described above, performing a coating treatment and an alloying treatment and subsequently heating the sheet up to a temperature of 300° C. or higher.

The present invention can provide a hot dip galvannealed steel sheet of excellent phosphatability in which the chemical ingredients of the hot dip galvannealed coating layer are controlled. When a chemical conversion treatment is applied to the hot dip galvannealed steel sheet, a dense chemical conversion coating can be obtained.

### BRIEF DESCRIPTION OF THE DRAWINGS

FIG. 1A illustrates an example of a profile (in full scale) of an Mn concentration without heating after an alloying treatment measured by GDOES (Glow Discharge Optical Emission Spectroscopy);

FIG. 1B illustrates an example of a profile (in full scale) of an Mn concentration with heating after the alloying treatment measured by GDOES (Glow Discharge Optical Emission Spectroscopy);

FIG. 2A illustrates an example of a profile (in full scale) of an Fe concentration and a Zn concentration without heating after the alloying treatment measured by GDOES;

FIG. 2B illustrates an example of a profile (in full scale) of an Fe concentration and a Zn concentration with heating after the alloying treatment measured by GDOES;

FIG. 3A illustrates an example of a profile of an Mn concentration (from the uppermost surface of a coating layer to 0.02 μm depth in the direction of the depth) without heating after the alloying treatment measured by GDOES;

FIG. 3B illustrates an example of a profile of an Mn concentration (from uppermost surface of a coating layer to 0.02 μm depth in the direction of the depth) with heating after the alloying treatment measured by GDOES;

FIG. 4A illustrates an electron microscopic photograph at the surface of a chemical conversion coating in an example without heating after the alloying treatment; and

FIG. 4B illustrates an electron microscopic photograph at the surface of a chemical conversion coating in an example with heating after the alloying treatment.

### DETAILED DESCRIPTION OF THE PREFERRED EMBODIMENTS

The present inventors have made earnest studies for obtaining a hot dip galvannealed steel sheet having high strength and high ductility and excellent in phosphatability. As a result, the present invention has been accomplished based on the finding that subjects of the invention can be attained by controlling the chemical composition of the material steel sheet (material sheet), particularly, by increasing the Mn concentration in the uppermost layer of the hot dip galvannealed coating layer (hereinafter sometimes referred to simply as “coating layer”) and it is effective to apply heating at a predetermined temperature after the alloying treatment in order to obtain the hot dip galvannealed steel sheet and heating the same at a predetermined temperature.

At first, the coating layer of the hot dip galvannealed steel sheet according to the invention is to be described.

### [Coating Layer in Hot Dip Galvannealed Steel Sheet]

The hot dip galvannealed steel sheet according to the invention has a most important feature of improving the phosphatability of the hot dip galvannealed steel sheet by defining the average Mn concentration (hereinafter sometimes referred to as “Mn concentration in the coated surface layer”) for a region from the uppermost surface to 0.01 μm depth of the coating layer (hereinafter, sometimes referred to as “coating surface layer region”) to 0.14% or more.

Although the reason that the phosphatability is improved by increasing the Mn concentration in the coating surface layer has not yet been apparent, it is considered that the dissolving rate at the galvanized surface is changed or the amount of Mn-series oxides increases due to increase in the Mn concentration of the coating surface layer thereby promoting growing of crystal nuclei in the zinc phosphate coating to result in refinement of crystal size.

The Mn concentration in the coating surface layer is preferably 0.15% or more and, more preferably, 0.16% or more. On the other hand, if the Mn concentration in the coating surface layer is excessively high, since the effect is saturated to increase the cost, the concentration is preferably 2.0% or less and, more preferably, 1.9% or less.

In the present invention, it may suffice that only the Mn concentration is defined to the range described above as an ingredient in the coating surface layer region and the kind and the content of other ingredients than Mn in the coating surface layer are not particularly restricted. The coating surface layer region may contain Zn, Fe, etc. in addition to Mn.

The Mn concentration in the entire coating layer (average Mn concentration in the entire coating layer) is preferably less than 1.0%. This is because the weldability (particularly, spot weldability) is deteriorated if the Mn concentration is excessive in the entire coating layer. In addition, it also increases the cost. More preferably, the Mn concentration in the entire coating layer is 0.95% or less.

The kind and the content of other ingredients than Mn in the entire coating layer are not particularly restricted. Further, also the kind and the content of the ingredients further inside of the depth of 0.01 μm from the uppermost surface of the coating layer (inside of the coating layer) are not restricted particularly excepting that the Mn concentration in the entire coating layer is defined within the recommended range. The entire coating layer contains Zn, Fe, etc. in addition to Mn in the inside of the coating layer.

The hot dip galvannealed steel sheet of the invention has the coating layer of the constitution described above at least on one surface of the material steel sheet.

Then, ingredients in the material steel sheet (material sheet) are to be described. In the invention, it is necessary to control the content of Si and Mn in the material steel sheet as described below so as to obtain a hot dip galvannealed steel sheet having high strength and high ductility. Other chemical ingredients provide no significant effects on the strength, the ductility, etc. or they have no remarkable effect on the phosphatability.

### [Chemical Composition of the Material Steel Sheet]

### [Si: 0.4 to 2.0%]

Si is an element in the steel that contributes to the increase of the strength of a steel sheet as a solid solution hardening element. Accordingly, the amount of Si is 0.4% or more and, preferably, 0.5% or more. However, if Si is contained excessively, the strength is increased excessively to increase a rolling load and, in addition, Si scales are generated on the surface of the material steel sheet upon hot rolling to worsen the surface property of the material steel sheet. Accordingly, the amount of Si is 2.0% or less, preferably, 1.95% or less.

### [Mn: 1.0 to 3.5%]

Mn in the steel is an essential element to increase the quenchability and increase the strength of the steel sheet. For obtaining the effect, the amount of Mn is 1.0% or more and, preferably, 1.1% or more. However, if Mn is contained excessively, this degrades the workability by segregation. Accordingly, the amount of Mn is 3.5% or less and, preferably, 3.4% or less.

Examples of the hot dip galvannealed steel sheet of the invention include those having the contents of C. P. S and Al in the material steel sheet satisfying the range described below.

### [C: 0.03 to 0.30%]

C is an element in the steel that enhances the strength of a steel sheet. Accordingly, for ensuring higher strength, the amount of C is preferably 0.03% or more and, more preferably, 0.04% or more. However, since the weldability is deteriorated if the amount of C becomes excessive, it is preferred to restrict the amount of C to 0.30% or less and, more preferably, 0.25% or less.

### [P: 0.1% or Less]

Since P in the steel is an element that promotes the grain boundary fracture due to grain boundary segregation, it is desirably smaller and the upper limit thereof is preferably 0.1% and, more preferably, 0.05% or less.

### [S: 0.01% or Less]

If S is contained excessively in the steel, sulfide type inclusions are increased tending to lower the strength of the steel sheet. Accordingly, the upper limit of the amount of S is preferably 0.01%. More preferably, the amount of S is 0.005% or less.

### [Al: 0.01 to 0.5%]

Al in the steel is an essential element necessary for deoxidation. Therefore, it is preferred to incorporate Al by 0.01% or more. More preferably, it is 0.03% or more. However, when Al is contained in excess, not only the effect of deoxidation is saturated but also the amount of inclusions such as aluminum is increased to deteriorate the workability. Accordingly, the upper limit of the amount of Al is preferably 0.5%. The amount of Al is more preferably 0.3% or less.

The material steel sheet includes those capable of satisfying the chemical composition described above, with the balance being iron and inevitable impurities.

Further, when the following elements are contained each by an appropriate amount in addition to the elements described above, higher strength and further improvement in the corrosion resistance, etc. can be obtained.

[Cr: 1% or Less and/or Mo: 1% or Less]

Cr and Mo are solid solution hardening elements that act effectively for increasing the strength of a steel sheet. For obtaining the effect, it is preferred that Cr and Mo are contained each by 0.01% or more. However, if they are contained excessively, the effect is saturated to increase the cost. Accordingly, both of Cr and Mo are preferably 1% or less (more preferably, 0.5% or less).

[One or More of Members Selected from the Group Consisting of Ti: 0.2% or Less, Nb: 0.2% or Less and V: 0.3% or Less]

Each of Ti, Nb and V is an element which forms precipitates such as carbides or nitrides in the steel to strengthen the steel. Particularly, Ti acts effectively also for refining the crystal grains and enhancing the yield strength. For obtaining the effect, Ti is preferably contained by 0.01% or more.

However, if Ti is contained excessively, carbides are precipitated in a great amount on the grain boundary to lower local elongation. Accordingly, the amount of Ti is preferably 0.2% or less and, more preferably, 0.15% or less.

Further, Nb and V are elements that refine the crystal grain like Ti described above and act effectively for enhancing the strength without deteriorating the toughness. For obtaining the effect, Nb and V are preferably contained each by 0.01% or more. However, if they are contained excessively, the effect is saturated to increase the cost. Accordingly, the amount of Nb is preferably 0.2% or less and, more preferably, 0.15% or less. Further, the amount of V is preferably 0.3% or less and, more preferably, 0.25% or less. Ti, Nb and V may be contained alone, or a plurality of them may be contained in combination.

[Cu: 3% or Less and/or Ni: 3% or Less]

Each of Cu and Ni is a solid solution hardening element, which is an element having an effect of improving the strength of an steel sheet. Further, it is also an element improving the corrosion resistance of the steel sheet. For obtaining the effects, it is preferred that each of them is contained by 0.003% or more. However, if Cu is contained in excess of 3% or Ni is contained in excess of 3%, the effect is saturated to increase the cost. Accordingly, Cu is preferably 3% or less and, more preferably, 2.5% or less. Also Ni is preferably 3% or less and, more preferably, 2.5% or less. Cu and Ni may be contained each alone or they may be contained together.

### [B: 0.01% or Less]

B is an element for enhancing quenchability and improving the strength of a steel sheet. For obtaining the effect, B is contained preferably by 0.0005% or more. However, since the toughness of the steel sheet is deteriorated if B is contained excessively, the amount of B is preferably 0.01% or less and, more preferably, 0.005% or less.

### [Ca: 0.01% or Less]

Ca is an element of sphericalizing the form of sulfides in the steel to improve the workability. For obtaining the effect, it is contained preferably by 0.0005% or more. However, if Ca is contained in excess of 0.01%, the effect is saturated and this is wasteful from an economical point of view. Accordingly, the amount of Ca is preferably 0.01% or less and, more preferably, 0.005% or less.

### [Production Process of Hot Dip Galvannealed (GA) Steel Sheet]

For obtaining a hot dip galvannealed steel sheet according to the invention, after performing hot rolling (further, pickling and cold rolling) by a customary method to obtain a material steel sheet (material sheet), and after performing a heat treatment, a galvanizing treatment, and an alloying treatment in a continuous coating line by a customary method, the hot dip galvannealed steel sheet is heated at a temperature of 300° C. or higher and lower than the alloying temperature. By the heating, the Mn concentration in the coating surface layer can be increased with the Fe concentration being kept at the level of an alloying hot dip galvanized steel sheet (GA) and, as a result, a hot dip galvannealed steel sheet excellent in the phosphatability can be obtained.

The heating temperature is preferably 350° C. or higher. On the other hand, if the heating temperature is excessively high, the Fe concentration in the coating layer increases excessively to lower the anti-powdering property. Accordingly, the upper limit value of the heating temperature is preferably at a temperature lower than the alloying temperature and 550° C. or lower. It is preferably, 500° C. or lower and, more preferably, 450° C. or lower.

The heating time at the temperature is preferably one minute or more and, more preferably, 2 minutes or more. However, since the effect is saturated to increase the cost if the heating time at the temperature is excessively long, the heating time is preferably 60 minutes or less and, more preferably, 55 minutes or less.

The atmosphere upon heating is preferably an oxidizing atmosphere. This is because Mn concentration tends to be thickened in the coating surface layer region by adopting the oxidizing atmosphere. The oxidizing atmosphere includes, for example, an ambient atmosphere, an oxygen atmosphere, and a steam atmosphere.

Further, the heating method includes, for example, heating by electric supply, high frequency heating, heating by using an electric furnace or a gas furnace, etc.

As described above, a customary method can be adopted excepting heating after the alloying treatment.

Also the method of the heat treatment is not particularly restricted and, when the amount of Si in the material steel sheet is large as in the present invention, an oxidation and reduction method (method of oxidizing the surface of a steel sheet by heating in an oxidizing zone, and then applying reduction annealing in a reduction zone and applying coating treatment) is adopted preferably. The heating conditions may be the same as those in the usual method and include, for example, defining air/fuel ratio in the oxidizing zone to 0.9 to 1.4 and the dew point in the reduction zone to −30° C. to −60° C.

Conditions for the hot dip galvanizing treatment are not particularly restricted and known conditions can be adopted. For example, the conditions include controlling the Al concentration in the hot dip galvanizing bath to 0.05 to 0.20 mass % or controlling the temperature of the hot dip galvanizing bath to about 400 to 500° C.

Further, the coating amount (on one surface) is not particularly restricted and, for example, within a range from 20 to 100 g/m².

Further, alloying conditions are not particularly restricted and known conditions can be adopted. For example, the alloying temperature is defined to about 400 to 600° C.

### Example

The present invention is to be described more specifically by way of examples. It will be apparent that the invention is not restricted to the following examples but can be practiced with appropriate modifications within a range conforming to the gist of the invention to be described later and all of such modifications are included in the technical range of the invention.

After heating slabs having chemical composition (the balance being iron and inevitable impurities) shown in Table 1 to a temperature within a range of 1000 to 1300° C., hot rolling was performed by a customary method, and the slabs were cooled to 500 to 700° C. and taken up into rolls. After taking up the respective rolls, they were subjected to pickling and cold rolling to obtain material sheets (material steel sheets).

After oxidizing the material steel sheets in a continuous coating line in an atmosphere at an air/fuel ratio of 0.9 to 1.4 in an oxidizing zone and then reducing and soaking them in an atmosphere containing hydrogen and nitrogen at a dew point of −30 to −60° C. and at a temperature of 800 to 900° C. in a reduction zone, they were cooled at a rate of 5-10° C./sec, coated in a galvanizing bath containing Al at a concentration of 0.05 to 0.20 mass % at 450 to 470° C., wiped and then put to an alloying treatment at 460 to 550° C.

JIS No. 5 specimens were sampled from the thus obtained hot dip galvannealed steel sheets, which were subjected to a tensile test to examine tensile characteristics [tensile strength (TS), yield strength (YS), and elongation (El)]. The strain rate in the tensile test was set to 1 mm/sec. It was judged that those having a tensile strength (TS) of 590 MPa or more had high strength and those having elongation (El) of 8% or more had high ductility. Then, specimens in which the amount of Si and the amount of Mn in the material sheets (material steel sheets) satisfied the defined range, and showing high strength and high ductility after the coating treatment were used and further subjected to the following heating treatment.

That is, specimens were cut out from steel sheets taken up by way of a skin path rolling in a continuous coating line step and subjected to infrared heating. The heating was performed under the heating conditions described in Table 2. Further, the heating atmosphere was a surrounding atmosphere.

The thus obtained hot dip galvannealed steel sheets (sample) were used and evaluated as described below.

### [Analysis for Ingredients in the Entire Coating Layer]

Ingredients in the entire coating layer were analyzed by dipping the galvanized steel sheets (specimens) in a 18% hydrochloric acid solution with addition of hexamethylene tetramine, dissolving only the coating layer and analyzing the solution by ICP (ICPS-7510, manufactured by Shimazu Corp.). Table 2 shows the concentration of Mn and the concentration of Fe for the entire coating layer.

[Average Mn Concentration from the Uppermost Surface to 0.01 μm Depth in the Coating Layer]

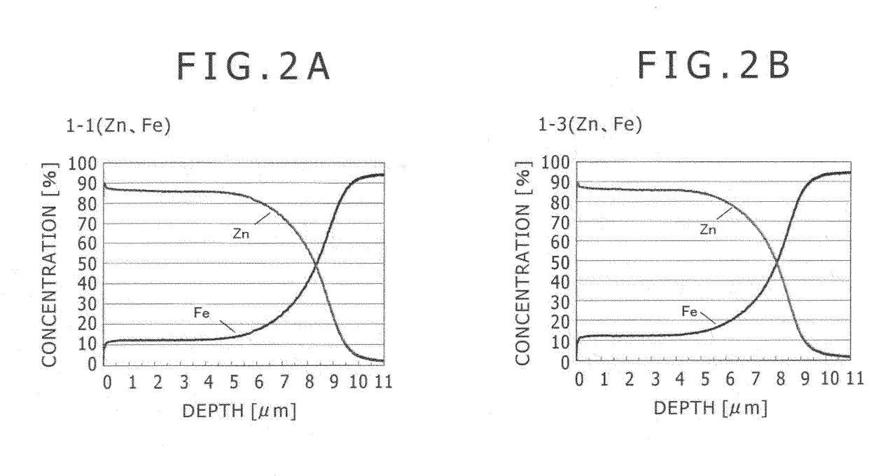

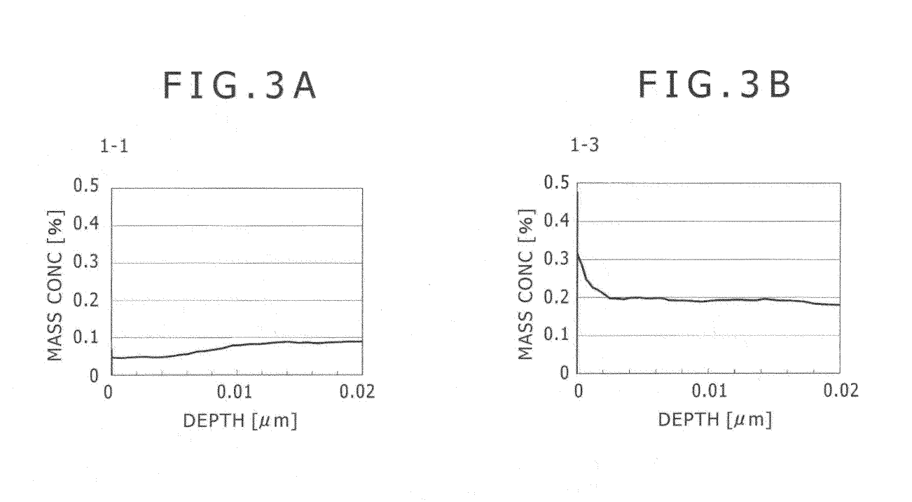

The Mn concentration in the coating surface layer was determined by GDOES (Glow Discharge Optical Emission Spectroscopy) (GDA750, manufactured by SPECTRUMA ANALYTIK GmbH). Specifically, in the analysis method, a profile of the Mn concentration in the direction of depth in the coating layer of the specimen was determined as shown in FIGS. 2A and 2B and FIGS. 3A and 3B to be described later, and the Mn concentration from the surface layer to 0.01 μm depth was defined in this concentration profile at a substantially equal pitch (at about 10 points including the surface layer and the 0.01 μm depth). The Mn concentration from the surface layer to the 0.01 μm depth was integrated by using the values (Mn concentration) and the integrated value was divided by 0.01 μm. Measurement was performed at 10 or more sites on the surface of the coating layer and an average value thereof was determined. Table 2 shows the result. In Table 2, the Mn concentration in the surface coating layer is lower than the Mn concentration in the entire coating layer because the measuring methods are different between them.

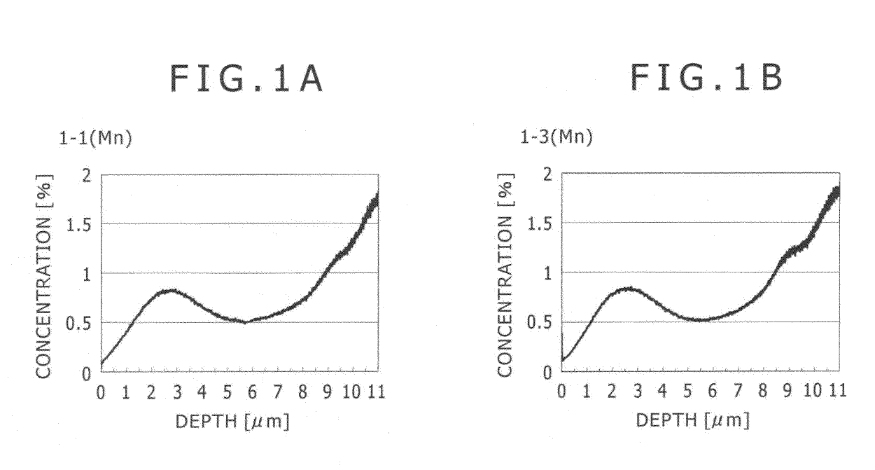

FIGS. 1A and 1B show examples of profiles of the Mn concentration from the uppermost surface to 11 μm depth (full scale) of the coating layer measured by GDOES (No. 1-1, No. 1-3) in which FIG. 1A illustrates the result of measurement with no heating after the alloying treatment (before heating after the alloying treatment) and FIG. 1B illustrates the result of measurement after the heating. Further, FIGS. 2A and 2B show the result of measurement for the Fe concentration and the Zn concentration in the same manner as in FIGS. 1A and 1B in which FIG. 2A illustrates the result of measurement before heating (with no heating) and FIG. 2B illustrates the result of measurement after the heating. In view of the results of FIGS. 1A and 1B and FIGS. 2A and 2B, no remarkable change can be confirmed for the concentration of each of the elements in the full scale before and after the heating.

On the contrary, FIGS. 3A and 3B illustrate the profile in FIGS. 1A and 1B from the uppermost surface to the 0.02 μm depth in the coating layer while enlarging the scale on the abscissa in which FIG. 3A illustrates a result of measurement before heating (with no heating) and FIG. 3B illustrates a result of measurement after the heating. In view of comparison between FIG. 3A and FIG. 3B, it can be seen that the Mn concentration close to the uppermost surface layer in the coating layer is increased after heating. On the other hand, Fe and Zn in the coating layer illustrated in FIGS. 2A and 2B does not cause such difference between heating and after heating even when the scale on the abscissa in FIGS. 2A and 2B is enlarged to the depth of 0.02 μm.

In view of the result, it can be seen that only the Mn concentration can be increased with no remarkable change in the concentration distribution for other elements than Mn in the coating surface layer region according to the invention and, as a result, the phosphatability of the coating layer can be improved without lowering the anti-powdering property due to increase of Fe in the coating layer, etc.

### [Evaluation of Phosphatability]

After performing alkali degreasing (FC-E2032 manufactured by NIHON PARKERIZING CO., LTD, 40° C., 120 sec) to the obtained hot dip galvannealed steel sheets, and surface conditioning (PL-Z manufactured by NIHON PARKERIZING CO., LTD, ambient temperature, 30 sec), chemical conversion (PB-L3020, manufactured by NIHON PARKERIZING CO., LTD, 40° C., 120 sec) was applied.

Then, the surface after the chemical conversion (5 view fields in total) were observed under an SEM (VE-8800 manufactured by Kabushiki Kaisha Keyence Co., JP), an average grain size (circle-equivalent diameter) of phosphate crystals was measured to calculate an average value for 5 view fields. When the average grain size of the phosphate crystals (circle-equivalent diameter) was less than 10 μm, it was judged as “◯” (excellent phosphatability) and when the average particle size was 10 μm or more, it was judged as “X” (poor phosphatability). The result is shown in Table 2.

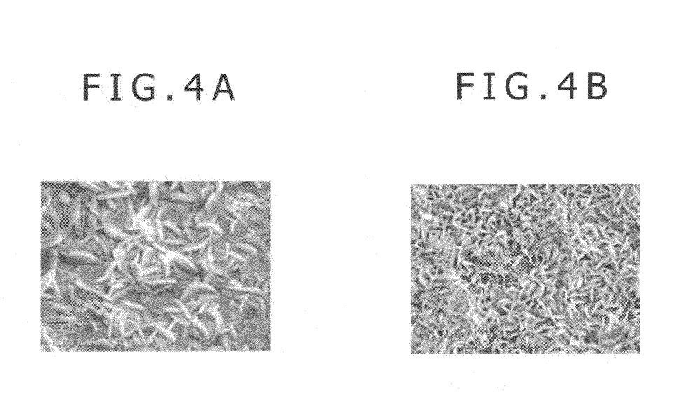

FIGS. 4A and 4B illustrate an example of an electron microscopic photograph. FIG. 4A is an electron microscopic photograph for the surface of the chemical conversion coating of a comparative example (No. 2-1) not applying the predetermined heating of the invention. FIG. 4B is an electron microscopic photograph for the surface of the chemical conversion coating of the example of the invention (No. 2-6) applying a predetermined heating. In view of comparison between FIG. 4A, FIG. 4B, it can be seen that chemical conversion coating of fine phosphate crystals is formed by the chemical conversion according to the invention, which is excellent in the phosphatability.

TABLE 1

| Material | Chemical Composition (mass %) Iron and inevitable impurity as the balance | | | | | | | | TS | YS | EI |
|---|---|---|---|---|---|---|---|---|---|---|---|
| sheet No. | C | Si | Mn | Cr | Ti | P | S | Al | (MPa) | (MPa) | (%) |
| Material | 0.062 | 1.10 | 1.82 | — | — | 0.01 | 0.002 | 0.04 | 595 | 348 | 36.4 |
| sheet 1 | | | | | | | | | | | |
| Material | 0.121 | 1.46 | 2.65 | 0.21 | 0.02 | 0.01 | 0.001 | 0.04 | 1197 | 849 | 13.6 |
| sheet 2 | | | | | | | | | | | |
| Material | 0.099 | 1.38 | 2.03 | — | — | 0.02 | 0.003 | 0.05 | 824 | 514 | 23.2 |
| sheet 3 | | | | | | | | | | | |
| Material | 0.107 | 1.76 | 2.08 | 0.11 | 0.06 | 0.01 | 0.001 | 0.04 | 1045 | 682 | 17.1 |
| sheet 4 | | | | | | | | | | | |
| Material | 0.083 | 0.34 | 0.87 | — | — | 0.01 | 0.001 | 0.04 | 419 | 283 | 33.0 |
| sheet 5 | | | | | | | | | | | |
| Material | 0.174 | 2.14 | 3.61 | — | — | 0.02 | 0.002 | 0.04 | 1326 | 988 | 7.0 |
| sheet 6 | | | | | | | | | | | |

TABLE 2

| | | | | Coating layer | | | | |
|---|---|---|---|---|---|---|---|---|
| | | | | | Mn | Fe | Mn | |
| | | | | Deposition | concentration | concentration | concentration | |
| | | Heating condition | | amount | in the entire | in the entire | in the surface | |
| | Material | | Time | (one side) | coating layer | coating layer | layer | |
| No. | sheet No. | Temperature(° C.) | (min) | g/m² | (Mass %) | (Mass %) | (Mass %) | Phosphatability |
| 1-1 | Material | none | 0 | 50 | 0.5 | 12 | 0.06 | x |
| 1-2 | sheet 1 | 200 | 5 | 50 | 0.5 | 12 | 0.07 | x |
| 1-3 | | 300 | 1 | 50 | 0.5 | 12 | 0.20 | ∘ |
| 1-4 | | | 3 | 50 | 0.5 | 12 | 0.20 | ∘ |
| 1-5 | | | 5 | 50 | 0.5 | 12 | 0.18 | ∘ |
| 2-1 | Material | none | 0 | 40 | 0.9 | 12 | 0.05 | x |
| 2-2 | sheet 2 | 100 | 5 | 40 | 0.9 | 12 | 0.05 | x |
| 2-3 | | 200 | 5 | 40 | 0.9 | 12 | 0.08 | x |
| 2-4 | | 300 | 1 | 40 | 0.9 | 12 | 0.20 | ∘ |
| 2-5 | | | 3 | 40 | 0.9 | 12 | 0.31 | ∘ |
| 2-6 | | | 5 | 40 | 0.9 | 12 | 0.34 | ∘ |
| 2-7 | | 400 | 5 | 40 | 0.9 | 12 | 0.50 | ∘ |
| 2-8 | | | 15 | 40 | 0.9 | 12 | 0.45 | ∘ |
| 3-1 | Material | none | 0 | 40 | 0.8 | 10 | 0.05 | x |
| 3-2 | sheet 3 | 200 | 5 | 40 | 0.8 | 10 | 0.06 | x |
| 3-3 | | 300 | 1 | 40 | 0.8 | 10 | 0.17 | ∘ |
| 3-4 | | | 3 | 40 | 0.8 | 10 | 0.15 | ∘ |
| 3-5 | | | 5 | 40 | 0.8 | 10 | 0.19 | ∘ |
| 4-1 | Material | none | 0 | 45 | 0.5 | 13 | 0.12 | x |
| 4-2 | sheet 4 | 200 | 5 | 45 | 0.5 | 13 | 0.13 | x |
| 4-3 | | 300 | 1 | 45 | 0.5 | 13 | 0.25 | ∘ |
| 4-4 | | | 3 | 45 | 0.5 | 13 | 0.20 | ∘ |
| 4-5 | | | 5 | 45 | 0.5 | 13 | 0.27 | ∘ |

In view of Table 1 and Table 2 it can be considered as below. At first in Table 1, the material sheets 1 to 4 indicate high strength and high ductility since the concentration of Si and that of Mn in the material sheet are within the predetermined range. On the contrary, no sufficient strength can be obtained in the material sheet 5 since the concentrations of Si and Mn are low. Further, the material sheet 6 can ensure high strength but is poor in the ductility since the both of the concentrations of Si and Mn are high.

In Table 2, heating after the alloying treatment is not conducted for Nos. 1-1, 2-1, 3-1, and 4-1. As a result, the Mn concentration in the coating surface layer is low and their phosphatability is poor.

Further, heating is performed after the alloying treatment for Nos. 1-2, 2-2, 2-3, 3-2, and 4-2 but since the heating temperature is below 300° C., the Mn concentration in the coating surface layer is not sufficient and the phosphatability is poor.

On the contrary, in Nos. 1-3 to 1-5, 2-4 to 2-8, 3-3 to 3-5, and 4-3 to 4-5, since heating is performed at 300° C. or higher after the alloying treatment to attain the Mn concentration of 0.14% or more in the coating surface layer, they are excellent in the phosphatability.

What is claimed is:

1. A hot dip galvannealed steel sheet in which
chemical composition in the material steel sheet comprises 0.4 to 2.0% of Si (% by mass for the chemical ingredient here and hereinafter) and 1.0 to 3.5% of Mn, and
the average Mn concentration for a region from the uppermost surface to 0.01 μm depth in the coating layer is 0.14% or more.

2. A hot dip galvannealed steel sheet according to claim 1, wherein
the chemical composition of the material steel sheet comprises 0.03 to 0.30% of C, 0.1% or less of P, 0.01% or less of S, and 0.01 to 0.5% of Al.

3. A hot dip galvannealed steel sheet according to claim 1, wherein
the Mn concentration in the entire coating layer is less than 1.0%.

4. A process for producing a hot dip galvannealed steel sheet according to claim 1, wherein
the process includes a step of using a material steel sheet having 0.4 to 2.0% of Si and 1.0 to 3.5% of Mn, performing a coating treatment and an alloying treatment and subsequently, performing heating at a temperature of 300° C. or higher.
